(19) United States
(12) Patent Application Publication
(10) Pub. No.: US 2014/0278415 A1
(43) Pub. Date: Sep. 18, 2014

(54) Voice Recognition Configuration Selector and Method of Operation Therefor

(71) Applicant: Motorola Mobility LLC, Libertyville, IL (US)

(72) Inventors: Plamen A. Ivanov, Schaumburg, IL (US); Joel A. Clark, Woodridge, IL (US)

(73) Assignee: Motorola Mobility LLC, Libertyville, IL (US)

(21) Appl. No.: 13/955,187

(22) Filed: Jul. 31, 2013

Related U.S. Application Data
(60) Provisional application No. 61/828,054, filed on May 28, 2013.
(60) Provisional application No. 61/776,793, filed on Mar. 12, 2013.
(60) Provisional application No. 61/798,097, filed on Mar. 15, 2013.

(51) Int. Cl. G10L 15/06

(52) U.S. Cl. CPC G10L 15/063
USPC 704/246

(57) ABSTRACT

A method includes obtaining a speech sample from a pre-processing front-end of a first device, identifying at least one condition, and selecting a voice recognition speech model from a database of speech models, the selected voice recognition speech model trained under the at least one condition. The method may include performing voice recognition on the speech sample using the selected speech model. A device includes a microphone signal pre-processing front end and operating-environment logic, operatively coupled to the pre-processing front end. The operating-environment logic is operative to identify at least one condition. A voice recognition configuration selector is operatively coupled to the operating-environment logic, and is operative to receive information related to the at least one condition from the operating-environment logic and to provide voice recognition logic with an identifier for a voice recognition speech model trained under the at least one condition.

### CROSS-REFERENCE TO RELATED APPLICATIONS

The present application claims priority to U.S. Provisional Patent Application No. 61/828,054, filed May 28, 2013, entitled “VOICE RECOGNITION CONFIGURATION SELECTOR AND METHOD OF OPERATION THEREFOR” which is incorporated in its entirety herein, and further claims priority to U.S. Provisional Patent Application No. 61/798,097, filed Mar. 15, 2013, entitled “VOICE RECOGNITION FORA MOBILE DEVICE,” and further claims priority to U.S. Provisional Pat. App. No. 61/776,793, filed Mar. 12, 2013, entitled “VOICE RECOGNITION FOR A MOBILE DEVICE,” all of which are assigned to the same assignee as the present application, and all of which are hereby incorporated by reference herein in their entirety.

### FIELD OF THE DISCLOSURE

The present disclosure relates generally to voice recognition systems and more particularly to apparatuses and methods for improving voice recognition performance.

### BACKGROUND

Mobile devices such as, but not limited to, mobile phones, smart phones, personal digital assistants (PDAs), tablets, laptops, home appliances or other electronic devices, etc., increasingly include voice recognition systems to provide hands free voice control of the devices. Although voice recognition technologies have been improving, accurate voice recognition remains a technical challenge.

A particular challenge when implementing voice recognition systems on mobile devices is that, as the mobile device moves or is positioned in certain ways, the acoustic environment of the mobile device changes accordingly thereby changing the sound perceived by the mobile device's voice recognition system. Voice sound that may be recognized by the voice recognition system under one acoustic environment may be unrecognizable under certain changed conditions due to mobile device motion or positioning. Various other conditions in the surrounding environment can add noise, echo or cause other acoustically undesirable conditions that also adversely impact the voice recognition system.

The mobile device acoustic environment impacts the operation of signal processing components such as microphone arrays, noise suppressors, echo cancellation systems and signal conditioning that is used to improve voice recognition performance. Another challenge is that such signal processing, specifically pre-processing that is used on mobile devices also impacts the operation of voice recognition. More particularly, a speech training model that was created on a given device using a given set of pre-processing criteria will not operate properly under a different set of pre-processing conditions.

### BRIEF DESCRIPTION OF THE DRAWINGS

FIG. 1 is an illustration of a graph of speech recognition performance distribution that may occur where the distribution for a two-dimensional feature vector is altered by pre-processing the same set of signals.

FIG. 2 is a flowchart providing an example method of operation for speech model creation for a given processing condition.

FIG. 3 is a flowchart providing an example method of operation for database creation for a set of processing conditions in various environments.

FIG. 4 is a flow chart providing an example method of operation in accordance with various embodiments.

FIG. 5 is a diagram of an example cloud based distributed voice recognition system.

FIG. 6 is schematic block diagram of an example applicable to various embodiments.

### DETAILED DESCRIPTION

Briefly, the disclosed embodiments enable dynamically switching voice recognition databases based on noise or other conditions. In accordance with the embodiments, information from the pre-processing components working on a mobile device, or other device employing voice recognition, may be utilized to control the configuration of a voice recognition system, in order to render the voice recognition system optimal for the conditions in which the mobile or other device operates. Sensor data and other information may also be used to determine such conditions.

A disclosed method of operation includes obtaining a speech sample from a pre-processing front-end of a first device, identifying at least one condition related to pre-processing applied to the speech sample by the pre-processing front-end or related to an audio environment of the speech sample and selecting a voice recognition speech model from a database of speech models. The selected voice recognition speech model is trained under the at least one condition. The method may further include performing voice recognition on the speech sample using the selected speech model.

In some embodiments, identifying at least one condition, may include identifying at least one of: a physical or electrical characteristics of the first device; level, frequency and temporal characteristics of a desired speech source; location of the desired speech source with respect to the first device and surroundings of the first device; location and characteristics of interference sources; level, frequency and temporal characteristics of surrounding noise; reverberation present in the environment; physical location of the device; or characteristics of signal enhancement algorithms used in the first device pre-processing front-end.

The method of operation may also include providing an identifier of the voice recognition speech model to voice recognition logic. In some embodiments, the method may also include providing the identifier of the voice recognition speech model to the voice recognition logic located on a second device or located on a server.

The present disclosure also provides a device that includes a microphone signal pre-processing front end and operating-environment logic, operatively coupled to the microphone signal pre-processing front end, and operative to identify at least one condition related to pre-processing applied to obtained speech samples by the microphone signal pre-processing front end or related to an audio environment of the obtained speech samples. A voice recognition configuration selector is operatively coupled to the operating-environment logic. The voice recognition configuration selector is operative to receive information related to the at least one condition from the operating-environment logic and to provide the voice recognition logic with an identifier for a voice recognition speech model trained under the at least one condition.

The device may further include voice recognition logic, operatively coupled to the voice recognition configuration selector and to a database of speech models. The voice recognition logic is operative to retrieve the voice recognition speech model trained under the at least one condition, based on the identifier received from the voice recognition configuration selector. In some embodiments, a plurality of sensors may be operatively coupled to the operating-environment logic. Also, some embodiments may include location information logic operatively coupled to the operating-environment logic.

Turning now to the drawings, FIG. 1 is an illustration of changes in distribution that may occur for a two-dimensional feature vector altered by pre-processing the same set of signals. Voice recognition systems are trained on data that is often not acquired on the same device or under the same environmental conditions. The audio signal sent to a voice recognition system often undergoes various types of signal conditioning that are needed to, for example, adjust gain/limit, frequency correct/equalize, de-noise, de-reverberate, or otherwise enhance the signal. All of this “pre-processing” is intended to result in a higher quality audio signal thereby resulting in higher intelligibility for a human listener. Such pre-processing often has statistics altered sufficiently enough to decrease the recognition performance of a voice recognition system trained under entirely different conditions. This alteration is illustrated in FIG. 1 which shows distribution changes in a feature vector for a known dataset with and without additional processing. As is shown in FIG. 1, pre-processing changes the normal distribution such that the voice recognition may, or may not, recognize speech. Accordingly, the present embodiments may use of voice recognition speech models created for given pre-processing conditions.

Turning to FIG. 2, a flowchart provides an example method of operation for speech model creation for a given processing condition. In one embodiment, a voice recognition system will be trained under a number of different conditions. The voice recognition system achieves optimal performance for observations obtained under the training condition, but not necessarily optimal if the observation came for another condition different than that used in training. Thus the method of operation begins and in operation block 201, voice recognition engine is trained with a training set under a first condition. In operation block 203, the voice recognition engine is tested with inputs obtained under the first condition. The inputs may or may not include the data used during training. If the test is successful in decision block 205, then the model for the first condition is stored in operation block 207 and the method of operation ends. Otherwise, the training under the first condition training set is repeated in operation block 201.

The conditions will be selected so as to cover the intended use as much as possible. The condition may be identified as, for example, “trained on device X” (i.e. a given device type and model), “trained in environment Y” (i.e. noise type/level, acoustic environment type, etc.), “trained with signal conditioning Z” (specifying any relevant pre-processing such as, for example, gain settings, noise reduction applied, etc.), “trained with other factor(s)” such as those affecting the voice recognition engine, or combination thereof. In other words, a “condition” may be related to the training device, the training environment or the training signal conditioning including pre-processing applied to the audio signal.

In one example, the voice recognition system can be trained on a given mobile device with signal conditioning algorithms turned off in multiple environments (such as in a car, restaurant, airport, etc.), and with signal conditioning enabled in the same environments. Each time a speech-model data-base ensuring optimal voice recognition performance is obtained and stored. FIG. 3 provides an example of such a method of operation for database creation for a set of processing conditions in various environments. As shown in operation block 301, a model is obtained under a first condition, then under a second condition in operation block 303, and so on, until an Nth condition in operation block 305 at which point the method of operation ends. The number of conditions and situations covered is limited by resource availability and can be extended as new conditions and needs are identified.

Once trained, the voice recognition system may operate as illustrated in FIG. 4 which illustrates a method of operation in accordance with various embodiments. In operation block 401, a pre-processing front end will collect a speech sample of interest, and operating-environment logic, in accordance with the embodiments, will measure and identify the condition under which the observation is made as shown in operation block 403. Data collected from the operating-environment logic will be combined with the speech sample and passed to the voice recognition system by, for example, an application programming interface (API) 411. In operation block 405, a voice recognition configuration selector will process the information about the conditions under which observation was made and will select the data-base best representing the condition in which the speech sample was obtained. The database identifier (DB ID 413) identifies the selected speech model from among the collection of databases 409. In operation block 407, the voice recognition engine will then use the selected speech model optimal for the current conditions and will process the sample of speech, after which it will return the result. The method of operation then returns to operation block 401.

The methods of operation described above do not impose limits on the possible architecture of the overall voice recognition system. For example, in some embodiments, and in the example of FIG. 4, the voice recognition engine and voice recognition configuration selector operations, illustrated by the dotted line around operations 400, and the pre-processing front end may be located on the same device, or may be located on separate devices. For example, as shown in FIG. 5, voice recognition front end processing may be on a various mobile devices (e.g. smartphone 509, tablet 507, laptop 511, desktop computer 513 and PDA 505), while a networked server 501 is operative to process requests from the multiple front-ends, which be mobile devices, or other networked systems as shown in FIG. 5 (such as other computers, or embedded systems). In this example embodiment, the front-end will send packetized information containing speech and description of the conditions, over a network link 503 of a network 500 (such as the Internet) and will receive the response from the server 501, as illustrated in FIG. 5. Each user may represent a different condition as shown, such that the voice recognition configuration selector on server 501 may select different speech models according to each device's specific conditions including its pre-processing, etc.

A schematic block diagram in FIG. 6 provides an example applicable to various embodiments. A device 610, which may be any of the devices shown in FIG. 5 or some other device, may include a group of microphones 110 operatively coupled to microphone signal pre-processing front end 120. In accordance with the embodiments, operating-environment logic 130 collects information from various device 610 components such as, but not limited to, location information from location information logic 131, sensor data from a plurality of sensors 132 which may include, but are not limited to, photosensors, proximity sensors, position sensors, motions sensors, etc., or from the microphone signal pre-processing front end 120. Examples of operating-environment information obtained by the operating-environment logic may include, but is not limited to, a device ID for device 610, the signal conditioning algorithm used, a noise environment ID, a signal quality indicator, noise level, signal-to-noise ratio, or other information such as impeding (reflective/absorptive) nearby surfaces, etc. This information may be obtained from the microphone signal pre-processing front end 120, the sensors 132, other dedicated measurement logic, or from network information sources. The operating-environment logic 130 provides the operating-environment information 133 to the voice recognition domain 600 which, as discussed above, may be located on the device 610 or may be remotely located such as on a server or on another different device. That is, the voice recognition domain 600 may be distributed between various devices or between one or more devices and a server, etc. Thus, in one example of such a distributed approach, the operating environment logic 150 and the voice recognition configuration selector 140 may be located on the device, while the voice recognition logic 150 and voice recognition configuration database 160 are located on a server. Other distributed approaches may also be used in accordance with the various embodiments.

In one embodiment, the operating-environment logic 130 provides the operating-environment information 133 to the voice recognition configuration selector 140 which provides an optimal speech model ID 135 to voice recognition logic 150. Voice recognition logic 150 also received a speech sample 151 from the microphone signal pre-processing front end 120. The voice recognition logic 150 may then proceed to access the optimal speech model from voice recognition configuration database 160 using a suitable database communication protocol 152. In some embodiments, the operating environment logic 130 and the voice recognition configuration selector 140 may be integrated together on a single device. On other embodiments, the voice recognition configuration selector 140 may be integrated with the voice recognition logic 150. In such other embodiments, the operating environment logic 130 provides the operating-environment information 133 directly to the voice recognition logic 150 (which include the integrated voice recognition configuration selector 140).

The operating-environment logic 130, the voice recognition configuration selector 140 or microphone signal pre-processing front end may be implemented in various ways such as by software and/or firmware executing on one or more programmable processors such as a central processing unit (CPU) or the like, or by ASICs, DSPs, FPGAs hardwired circuitry (logic circuitry), or any combinations thereof.

Additional examples of the type of condition information that the operating-environment logic 130 may attempt to obtain include conditions such as, but not limited to, a) physical/electrical characteristics of the device; b) level, frequency and temporal characteristics of the desired speech source; c) location of the source with respect to the device and its surroundings; d) location and characteristics of interference sources; e) level, frequency and temporal characteristics of surrounding noise; f) reverberation present in the environment; g) physical location of the device (e.g. on table, hand-held, in-pocket etc.); or h) characteristics of signal enhancement algorithms. In other words, the condition may be related to pre-processing applied to obtained speech samples by the microphone signal pre-processing logic 120 or may be related to an audio environment of the obtained speech samples.

Additional examples of operating-environment information 133 sent by the operating-environment logic 130 to the voice recognition configuration selector 140 may include, but is not limited to, a) information to identify what device was used in the speech data observation (configuration decision can be based on selecting a database obtained with the device used, or one with similar characteristics); b) information identifying signal conditioning algorithms used, such as dynamic processors, filters, gain line-up, noise suppressor etc. (allowing determination to use a database trained with similar or identical signal conditioning); c) information identifying noise environment, in terms of characteristics such as stationary/non-stationary, car, babble, airport, level, signal-to-noise ratio etc. (allowing determination to use database trained under similar conditions); d) information identifying other characteristics of the external environment, affecting data observation such as presence of reflective/absorptive surfaces (portable laying on table, or car seat), high degree of reverberation (portable in highly reverberant/live environment, or on highly reflective surface); or e) information characterizing overall quality of signal, for example: low overall (or too high) signal level, frequency loss with specific characteristics etc. In other words, the operating-environment information 133 has information about at least one condition which may be related to pre-processing applied to obtained speech samples by the microphone signal pre-processing logic 120 or may be related to an audio environment of the obtained speech samples. The audio environment may be determined in a variety of ways, such as, but not limited to, collecting and aggregating sensor data from the sensors 132, using location information from location information logic 131, extracting audio environment data observed by the microphone signal pre-processing logic 120 or from other components of the device 610.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
obtaining a speech sample from a pre-processing front-end of a first device;
identifying at least one condition related to pre-processing applied to the speech sample by the pre-processing front-end or related to an audio environment of the speech sample; and
selecting a voice recognition speech model from a database of speech models, the selected voice recognition speech model trained under the at least one condition.

2. The method of claim 1, further comprising:
performing voice recognition on the speech sample using the selected speech model.

3. The method of claim 1, wherein identifying at least one condition, comprises:
identifying at least one of:
a physical or electrical characteristics of the first device;
level, frequency and temporal characteristics of a desired speech source;
location of the desired speech source with respect to the first device and surroundings of the first device;
location and characteristics of interference sources;
level, frequency and temporal characteristics of surrounding noise;
reverberation present in the environment;
physical location of the device; or
characteristics of signal enhancement algorithms used in the first device pre-processing front-end.

4. The method of claim 1, further comprising:
providing an identifier of the voice recognition speech model to voice recognition logic.

5. The method of claim 4, further comprising:
providing the identifier of the voice recognition speech model to the voice recognition logic located on a second device or located on a server.

6. The method of claim 4, further comprising;
selecting, by the voice recognition logic, the voice recognition speech model from a plurality of voice recognition speech models using the identifier.

7. A device comprising:
a microphone signal pre-processing front end;
operating-environment logic, operatively coupled to the microphone signal pre-processing front end, operative to identify at least one condition related to pre-processing applied to obtained speech samples by the microphone signal pre-processing front end or related to an audio environment of the obtained speech samples; and
a voice recognition configuration selector, operatively coupled to the operating-environment logic, operative to receive information related to the at least one condition from the operating-environment logic and to provide voice recognition logic with an identifier for a voice recognition speech model trained under the at least one condition.

8. The device of claim 7, further comprising;
voice recognition logic, operatively coupled to the voice recognition configuration selector and to a database of speech models, the voice recognition logic operative to retrieve the voice recognition speech model trained under the at least one condition, based on the identifier received from the voice recognition configuration selector.

9. The device of claim 7, further comprising:
a plurality of sensors, operatively coupled to the operating-environment logic.

10. The device of claim 9, further comprising:
location information logic, operatively coupled to the operating-environment logic.

11. A server comprising:
a database storing a plurality of voice recognition speech models with each voice recognition speech model trained under at least one condition; and
voice recognition logic, operatively coupled to the database, the voice recognition logic operative to access the database and retrieve a voice recognition speech model based on an identifier.

12. The server of claim 11, further comprising:
a voice recognition configuration selector, operatively coupled to the voice recognition logic, the voice recognition configuration selector operative to receive operating-environment information from a remote device, determine the identifier based on the operating-environment information, and provide the identifier to the voice recognition logic.

13. The server of claim 12, wherein the voice recognition configuration selector is further operative to determine the identifier based on the operating-environment information by identifying a voice recognition speech model trained under a condition related to the operating-environment information.

14. A method comprising;
training a voice recognition engine under at least one condition;
testing the voice recognition using voice inputs obtained under the at least one condition; and
storing a speech model for the at least one condition.

15. The method of claim 14, wherein training a voice recognition engine under at least one condition, comprises:
training a voice recognition engine under a pre-processing condition comprising at least one of gain settings or noise reduction applied.

16. The method of claim 14, wherein training a voice recognition engine under at least one condition, comprises:
training a voice recognition engine under an environment condition, comprising at least one of noise type present, noise level, or acoustic environment type.
